(19) United States
(12) Patent Application Publication
(10) Pub. No.: US 2006/0015844 A1
(43) Pub. Date: Jan. 19, 2006

(54) Automatic hardware and firmware generation for multi-function custom controls

(75) Inventors: Douglas A. Johnson, Groveland, MA (US); Stephen B. Boyd, Merrimac, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: WRD Corporation, Newburyport, MA (US)

(21) Appl. No.: 10/900,070

(22) Filed: Jul. 26, 2004

Related U.S. Application Data
(60) Provisional application No. 60/491,154, filed on Jul. 30, 2003.

(51) Int. Cl. G06F 9/44

(52) U.S. Cl. 717/106

(57) ABSTRACT

The invention is directed to automatic hardware and firmware generation preferably for multi-function custom control development. In particular, the invention involves generating the schematic and the firmware together, such that they integrate together to provide functionality as described in a functional description of the desired control. A method of automatic hardware and firmware generation includes (i) providing a plurality of hardware schematics, each schematic having a unique identifier corresponding to a set of functions; (ii) providing a plurality of firmware modules, each firmware module including code for performing a function; (iii) generating a functional description that identifies a desired set of functions; and (iv) processing the configuration file and the plurality of firmware modules to generate executable firmware code that implements the desired set of functions and to select one of the hardware schematics that supports the desired set of functions.

### RELATED APPLICATION

This application claims the benefit of U.S. Provisional Application No. 60/491,154, filed Jul. 30, 2003. The entire teachings of the above applications are incorporated herein by reference.

### COMPUTER PROGRAM LISTING APPENDIX

This application includes a computer program listing appendix on compact disc. A duplicate compact disc has also been provided. Each compact disc contains an ASCII text file of the computer program listing as follows:

| File Name | Date of Creation | Size (Bytes) |
|---|---|---|
| SYS-FIG.INC.TXT | Jul. 21, 2004 | 43,008 |
| SCH-FIG.INC.TXT | Jul. 21, 2004 | 22,528 |

The computer program listings contained in the above files are incorporated by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Control systems are ubiquitous in our modern society. Even with current technologies, designing custom control systems remains one of the most difficult, system engineering challenges. This difficulty translates directly into increased development time and cost.

There has been significant effort to address the difficulty in implementing custom control requirements. However, only modest gains in productivity improvements have been realized. Much of the recent emphasis has been on developing programming languages that enable higher levels of abstraction to be used to describe control system behavior. But such programming languages are complex and have not provided sufficient productivity gains for control system design.

Another methodology relates to platform development. When developing from a platform, the starting point is a known and fixed hardware/firmware base. Changes and additions are made based on the requirements of the intended application. In contrast to traditional “start from scratch” development methods, improvements in productivity come from the fact that the known hardware/firmware base is complete, enabling later stage application development. As the platform is reused repeatedly, the developer gains familiarity with the platform, resulting in further productivity. Furthermore, if the platform covers a wide application base, and is low enough in cost, it is possible to use the platform to cover multiple product offerings in multiple industries.

However, the task of providing an easily configured, general purpose hardware/firmware platform that facilitates significant system level schematic changes and is intended for use in a wide range of applications has been elusive. One type of platform development process is used in very specific, high volume consumer type products, like TV set-top products, cell phones, or digital multi-media products. While these platforms allow designers to quickly and inexpensively make modifications to the base platform offering, they require the designer to stay within the constraints of the available platform hardware. That is, they do not support new products requiring completely different hardware schematics and/or firmware. This type of platform does not provide general purpose capabilities that would make the platform more universally appropriate over a wide range of applications.

In a different type of platform implementation, companies provide hardware and software libraries, as a “platform.” Engineering services are then provided to mix-and-match these libraries and to add any custom requirements in order to yield a custom control. While this does provide developmental productivity gains over the “start from scratch” method, these processes are typically not automated, and it is still a difficult process to fit the firmware modules together, compile the finished schematic, and debug the result.

### SUMMARY

The present invention is a system and method of automatic hardware and firmware generation preferably for custom control development. In particular, the invention involves generating the hardware schematic and the firmware together, such that they provide functionality identified in a user-defined functional description of the control. Thus, for embodiments of the invention, the intended application is the driving force for the form of the control, not the other way around.

According to one embodiment, a database of hardware schematics and firmware modules is provided. Each of the hardware schematics defines a set of interconnected hardware components that supports a specific set of functions and is associated with a unique schematic identifier based on those functions. Each of the firmware modules includes code that implements a specific function. Preferably, the available set of firmware modules and hardware schematics are fully debugged and functioning for the desired functions.

To initiate automatic hardware and firmware generation, a functional description of the desired control is generated that identifies a desired set of functions and behaviors. The functional description is then processed, resulting in selection of one of the hardware schematics and generation of executable code from the available set of firmware modules based on the desired set of functions.

According to one embodiment, the functional description is implemented as an electronic configuration file, also referred to as an “include” file that is referenced, or “included,” in the code of each of the firmware modules. The configuration file may be edited or generated by a user to identify a desired set of functions and behaviors that the control is expected to provide. The configuration file may include a series of TRUE/FALSE labels for identifying those functions and behaviors. Variable values or macros may also be used in the configuration file to identify specific behaviors having different modes or states. The configuration file may be a text-based file that can be modified using a simple text editor. Alternatively, a graphical user interface may replace the text editor, thus allowing the user to graphically select the desired control functions and behaviors used to configure the hardware and firmware platform. The graphical representation would then be used to automatically generate the configuration text file.

For automated firmware generation, the configuration file is processed (e.g, compiled, assembled and/or linked) along with the firmware modules to generate the executable code that provides the desired set of functions and behaviors. Preferably, only firmware modules that correspond to the desired set of functions in the configuration file are assembled and linked into the final executable.

For automated hardware schematic generation, as the configuration file is processed, a schematic identifier is generated based on the selected functions in the configuration file. The generated schematic identifier corresponds to one of the hardware schematics that supports the desired set of functions. The schematic identifier may be embedded in a data field of the executable code for later extraction using known techniques to identify the selected hardware schematic. Alternatively, the schematic identifier may be output directly to the system designer from the processor (e.g., assembler, linker, or compiler).

According to one embodiment, the hardware schematics are top level schematics comprising a number of constituent low level schematic. Each low level schematic in turn corresponds to a particular function. Each top level schematic can be assigned a unique schematic identifier based on its constituent low level schematic components. For example, the unique identifier may be a series of bit patterns with each bit pattern corresponding to a constituent low level schematic. Since each of the low level schematics corresponds to a specific function, the schematic identifier that is generated during processing of the configuration file can be generated based on the desired set of functions in the configuration file and the bit patterns of the low level schematics that correspond to the desired functions.

Pre-existing circuit board modules may also be provided which allow immediate testing of the hardware and firmware choices for proof-of-concept, prototype evaluation, or alpha phase product testing. In cases where custom packaging is necessary, the net-list from the schematic(s) can be provided to facilitate new P.C. board(s) lay-outs.

Approximately 60-80% of the engineering required to design a custom control including schematics and firmware can be performed in about 3-5 minutes. This method significantly reduces the non-recurring engineering cost of a custom control and provides the option of custom controls to Original Equipment Manufacturers (OEMs) that have never considered them before.

Thus, with a functional description of a desired control, both the firmware and hardware schematic of an appropriate platform for the custom control may be generated and used by a system designer for further application specific development. Such embodiments do not constrain the designer to any particular platform. Rather, the present inventions enables rapid development of new products requiring completely different hardware schematics and/or firmware.

An advantage of the present invention is that as new control functions are developed, the hardware schematics and firmware modules that support those new functions can be added to the database for subsequent control development. The functional description can then be generated or modified to include the new functions for selection. In this way, the present invention can provide a hardware/firmware platform that is capable of constant evolution to a more general purpose platform.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a flow diagram of a process for automatic hardware and firmware generation for multi-function custom controls according to one embodiment.

FIG. 2 is a system diagram for automatic hardware and firmware generation for multi-function custom controls according to one embodiment.

FIG. 3A is a diagram that illustrates a computer system suitable for implementation of the invention according to one embodiment.

FIG. 3B is a diagram of the internal structure of a computer system suitable for implementation of the invention according to one embodiment.

FIG. 4 is a diagram that illustrates a network environment suitable for implementation of the invention according to one embodiment.

### DETAILED DESCRIPTION OF A PREFERRED EMBODIMENT

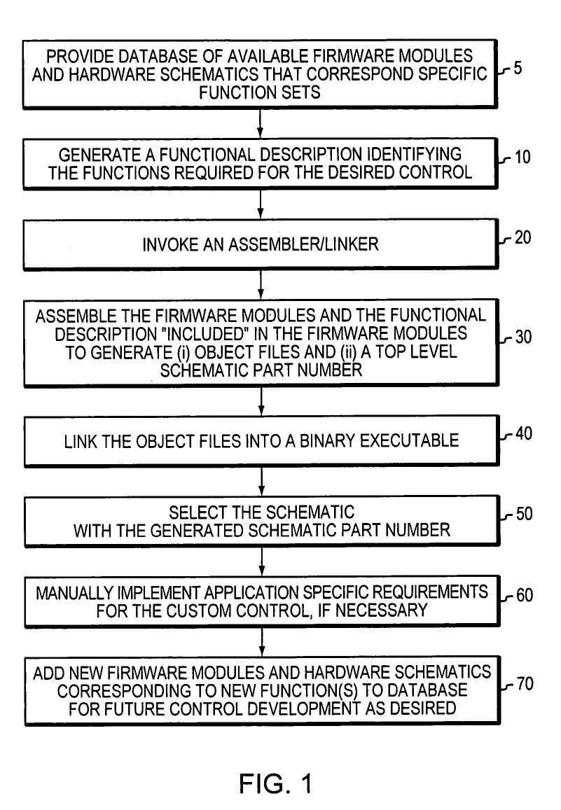

FIG. 1 is a flow diagram of a process for automatic hardware and firmware generation for multi-function custom controls according to one embodiment.

At 5, a database of available firmware modules and hardware schematics that correspond to specific function sets are provided. Preferably, each firmware module is a source file containing code for a specific function. Each of the hardware schematics can be a top level schematic of a control system that contains low level schematics of individual hardware components that each support a specific function.

At 10, a functional description is generated that identifies the functions required for the desired control. The functional description is preferably a modifiable text file that lists an available set of functions and/or behaviors that can be enabled or disable with TRUE/FALSE labels. Variable values and macros may also be used to specify behaviors having different states or modes. This functional description serves as the basis for selecting an hardware schematic and generating firmware for an appropriate platform for the desired control.

At 20, an assembler and/or linker is invoked.

At 30, the firmware modules and the functional description, which is preferably “included” or referenced in each of the firmware modules, are assembled to generate (i) object files and (ii) a top level schematic part number for the hardware schematic that supports the desired functions. According to one embodiment, one of the source files is the Schematic Part Number Generation source file. The result of the assembly of the Schematic Part Number Generation source file is an ASCII alpha/numeric field that is the Top Level Schematic Part Number of the Schematic that represents the choices selected in the TRUE/FALSE Functional Description File.

At 40, the object files are linked into a binary executable file, which is the executable firmware for the control system. According to one embodiment, the top level schematic part number may be embedded in an ASCII alpha/numeric field of the resulting executable. Alternatively, the schematic part number may be directly output to the system designer during assembly or linking according to other known techniques.

At 50, the schematic is selected from the database with the generated schematic part number. According to one embodiment, a system designer invokes a net list generator. The net list generator is a utility within a schematic database manager that selects the hardware schematic having the same part number. The net list generator then produces a net list for that schematic. The top level schematic and the net list represent a complete hardware description of the desired control system. If the part number is embedded in the executable, the system designer may also need to invoke a schematic part number extractor to get the part number of the Top Level Schematic that represents the selected functions.

At 60, application specific requirements for the custom control are manually implemented if necessary. Most custom controls have application specific requirements that must be manually implemented. A system designer may edit a modifiable source file and/or custom source file and also modify the selected top level schematic as required. The system designer then can start over with at 20, repeating this procedure to generate the binary executable and the schematic net list.

At 70, as new control functions are developed, the hardware schematics and firmware modules that support those new functions can be added to the database for subsequent control development. The functional description or functional description generator can then be updated to include the new functions for selection. In this way, the present invention can provide a hardware/firmware platform that is capable of constant evolution to a more general purpose platform.

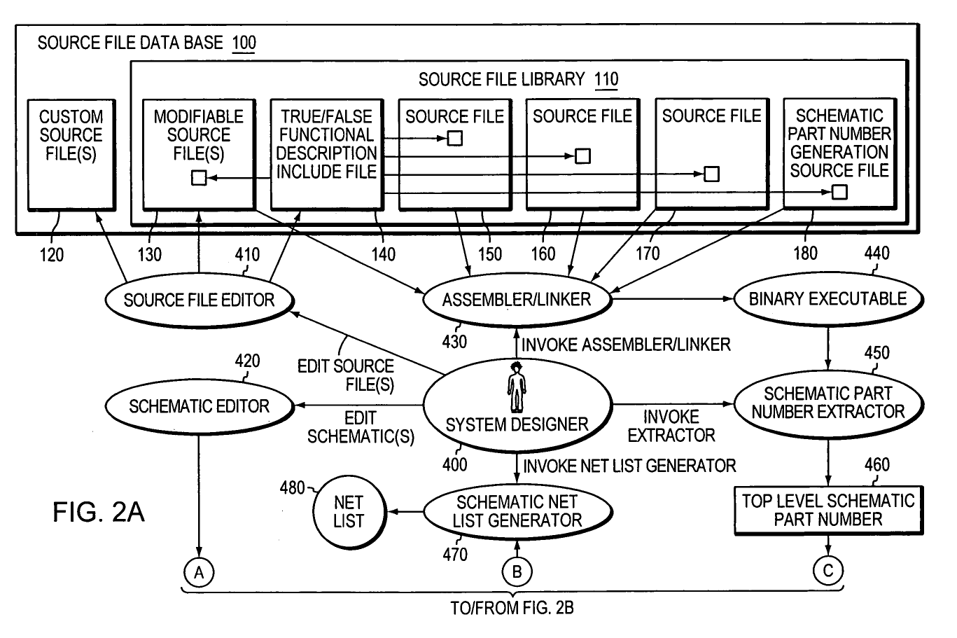

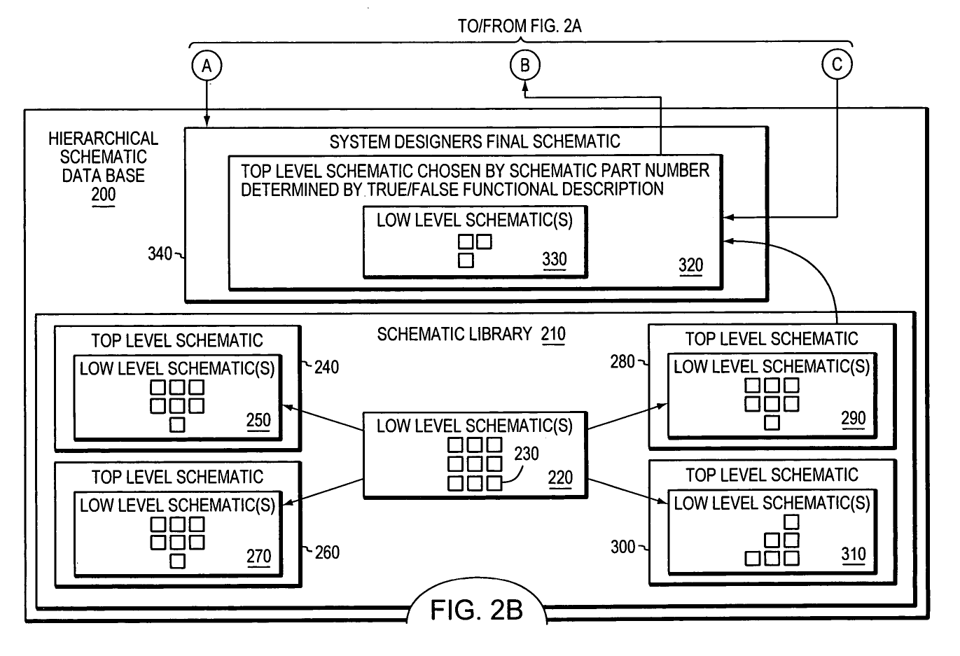

FIG. 2 is a system diagram for automatic hardware and firmware generation for multi-function custom controls according to one embodiment. In this illustrated embodiment, the database of available firmware modules and hardware schematics includes a source file database 100 and a hierarchical schematic database 200.

In particular, the firmware for the platform is made up of source files in the source file database 100. A source file library 110 of pre-generated source file modules exist within the database 100. One of these source files is the True/False Functional Description File 140. This is the file that can be edited by a system designer 400 using a source file editor 410 to select or otherwise identify the desired functions for the target control.

SYS-FIG.INC is an exemplary implementation of a True/False Functional Description File 140 according to one embodiment. (Refer to SYS-FIG.INC.TXT in computer program listing appendix that is incorporated by reference). In this implementation, the system designer edits the “TRUE” or “FALSE” labels to make his functional selections. There other types of functions which may require labels other than “TRUE” or “FALSE”, such as the size of the serial EEPROM. For example, in SYS-FIG.INC, a Hex number can be used to represent the size of the EEPROM. There are a plurality of settings of various types presented in this embodiment. One skilled in the art will recognize the significance of the settings and that various changes in form and details may be made therein without departing from the scope of the invention.

Another of these files is the Schematic Part Number Generation Source File 180. This file is preferably not edited by the system designer, but instead receives the True/False Functional Description file 140 as an “Include” file when the source files are assembled. When assembled with the include file, the Schematic Part Number Generation Source File 180 generates a 16 byte ASCII field which contains an 8 byte ASCII part number for the unique Top Level Schematic 320 that contains the Low Level Schematics 330 necessary to implement the functions selected in the Functional Description File 140. SCH-FIG.INC is an exemplary implementation of a Schematic Part Number Generation Source File 180 according to one embodiment (Refer to SCH-FIG.INC.TXT in computer program listing appendix that is incorporated by reference).

The source file library 110 may include a Modifiable Source File 130 that is a template to help the system designer organize some of the application specific requirements of the custom control. In one embodiment this file is referred to as EXECTSK.ASM. See Table 1 for a brief description of one embodiment of EXECTSK.ASM as well as a general discussion of an example implementation of other Source Files that make up the Source File Library 110 in the Source File Data Base 100.

The source file library may also provide additional source files 150, 160, and 170 that are available, with each source file providing additional functions that are available to the system designer. These various source files preferably have no overlapping functionality (i.e., each source file function is unique). If the behavior of a source file can be impacted by the application, the various behaviors are preferably fully described within the source file and made selectable using behavior settings (e.g. assembler directive true false settings and/or macros). These behavior setting labels are standardized for use by all source files, and are collected into a single configuration file for easy modification. (e.g. SYS FIG. INC (140)) See Table 1 for a general description of one embodiment of these source files.

In some cases it may be necessary for the system designer to create a custom source file 120 to implement an application specific function. Because the custom source file is preferably independent from the source file library, the library is not affected by the custom source file.

A standard assembler/linker 430 can be used to assemble and link the firmware modules of the source file library 110, including the True/False Functional Description File 140 and the Schematic Part Number Generation Source File 180 into a resultant binary executable 440. The schematic part number that is generated during this process may be embedded in the executable 440. Alternatively, the part number may be output using other known techniques.

If the schematic part number is embedded within the executable a schematic part number extractor 450 as known to those skilled in the art may be used to read or otherwise extract the part number from the executable 440. The generated schematic part number preferably corresponds to a top level schematic part number stored in the hierarchical schematic database 200.

According to one embodiment, the generated schematic part number may be input to a schematic net list generator 470 that uses the part number to select the appropriate top level schematic. The net list generator 470 can then provide a net list of the selected schematic that supports the desired set of functions identified in the user-defined functional description. The net list can then be used to generate a custom printed circuit board (PCB).

With respect to the hierarchical schematic database 200, the hardware for the platform is made up of Top Level Schematics 240, 260, 280, 300, as well as low level schematics 220. The collection of these schematics makes up the schematic library 210 that is used by the hierarchical schematic database 200 (e.g., OrCad SDT IV)

Many of the selectable functions in the True/False Functional description File 140 (e.g., SYS-FIG.INC) have direct hardware (low level schematic) counterparts. (e.g., EEPROM definition, RS232 definition, analog input definition, etc.) In the cases where there is a direct hardware counterpart to a functional description, a low level schematic is generated for that function 230. Thus the complete set of low level schematics 220 corresponds to all the functional selections in the Functional Description File 140 that have hardware counterparts. The individual low level schematics 230 are drawn in a Hierarchical Schematic Data Base 200 so that any particular low level schematic 230 can be included in a Top Level Schematic as a hierarchical block that references the low level schematic. The various Top Level Schematics 240, 260, 280, 300 only differ from each other in the combination of low level schematics 250, 270, 290, 310. By having hierarchical blocks that represent the various low level schematics, the various combinations of Top Level Schematics 240, 260, 280, 300 can be generated by simply including the hierarchical blocks that are desired. Thus it is possible to pre-configure Top Level Schematics for all usable combinations of selectable functions (low level schematics).

A schematic part numbering convention is provided, so that when the System Designer selects the desired functions (i.e., using the True/False Functional Description File—130), a unique part number is generated. That is, the part number is generated for the particular Top Level Schematic that includes the hardware counterparts to the user-selected functions.

Schematic Part Number Convention

According to one embodiment, top level schematics are named using the convention: “PABCDEFG.SCH” where the leading “P” indicates this is a top level schematic. The other letters, “A” through “G” are place holders for alphanumeric digits that are explained below. Any top level schematic (i.e. schematics that start with “P”) can be placed into a users final schematic to generate a finished hierarchical schematic. top level schematics are made up from lower level schematics.

Each letter placeholder “A”, “B”, “C”, “D”, “E”, “F”, “G” in the schematic part number can be either a digit 0-9 or any letter from alphabet, excluding the letters I,L,O,Q. Note: these characters can sometimes look alike. Thus, 0,1,2,3,4,5,6,7,8,9,A,B,C,D,E,F,G,H,J,K,M,N,P,R,S,T,U,V,W,X,Y,Z are used. This is preferably a base 32 numbering system. Each number can be further represented by 5 binary bits. The following chart shows the bit representations for the various base 32 numbers. These base 32 numbers are going to be the characters used in the placeholder locations (“A” through “G”) of the schematic part number.

| | | | | | Values to Use in |
|---|---|---|---|---|---|
| bit4 | bit3 | bit2 | bit1 | bit0 | Place of Place Holders |
| 0 | 0 | 0 | 0 | 0 | “0” |
| 0 | 0 | 0 | 0 | 1 | “1” |
| 0 | 0 | 0 | 1 | 0 | “2” |
| 0 | 0 | 0 | 1 | 1 | “3” |
| 0 | 0 | 1 | 0 | 0 | “4” |
| 0 | 0 | 1 | 0 | 1 | “5” |
| 0 | 0 | 1 | 1 | 0 | “6” |
| 0 | 0 | 1 | 1 | 1 | “7” |
| 0 | 1 | 0 | 0 | 0 | “8” |
| 0 | 1 | 0 | 0 | 1 | “9” |
| 0 | 1 | 0 | 1 | 0 | “A” |
| 0 | 1 | 0 | 1 | 1 | “B” |
| 0 | 1 | 1 | 0 | 0 | “C” |
| 0 | 1 | 1 | 0 | 1 | “D” |
| 0 | 1 | 1 | 1 | 0 | “E” |
| 0 | 1 | 1 | 1 | 1 | “F” |
| 1 | 0 | 0 | 0 | 0 | “G” |
| 1 | 0 | 0 | 0 | 1 | “H” |
| 1 | 0 | 0 | 1 | 0 | “J” |
| 1 | 0 | 0 | 1 | 1 | “K” |
| 1 | 0 | 1 | 0 | 0 | “M” |
| 1 | 0 | 1 | 0 | 1 | “N” |
| 1 | 0 | 1 | 1 | 0 | “P” |
| 1 | 0 | 1 | 1 | 1 | “R” |
| 1 | 1 | 0 | 0 | 0 | “S” |
| 1 | 1 | 0 | 0 | 1 | “T” |
| 1 | 1 | 0 | 1 | 0 | “U” |
| 1 | 1 | 0 | 1 | 1 | “V” |
| 1 | 1 | 1 | 0 | 0 | “W” |
| 1 | 1 | 1 | 0 | 1 | “X” |
| 1 | 1 | 1 | 1 | 0 | “Y” |
| 1 | 1 | 1 | 1 | 1 | “Z” |

Bit Definitions for the Various Placeholder Characters (“A”-“G”)
BIT DEFINITION FOR place holder character “A” (power & display options)
   bit 4,3=Wall power or Battery
      +Constant current source for large LCD backlight
      0,0=wall power & no constant current source
      0,1=wall power+constant current source for big back-light
      1,0=
      1,1=battery powered
bits 2,1,0=display size & type
   0,0,0=no LED or LCD display present
   0,0,1=LCD, single 14 pin header
   0,1,0=LCD, single 16 pin header (includes low current back-light)
   0,1,1=LCD, single 16 pin header=4×40 LCD (no back-light in header)
   1,0,0=
   1,0,1=
   1,1,0=
   1,1,1=LED Display with Remote LED Display 1 Opin header
BIT DEFINITION FOR place holder character “B” (cpu & csio options)
   bits 4,3,2=CPU configuration
      0,0,0=HD647180
      0,0,1=Z180+PSD511+PSD935
      0,1,0=Z180+KIO+PSD835
      0,1,1=Z180+buffers+latches
      1,0,0=Z180 minimum CPU
      1,0,1=EZ80+PSD835
      1,1,0=
      1,1,1=
   bits 1,0=Discrete LED indicators (serial-CSIO)
      (these are only allowed if the users display type is LCD)
      0,0=none
      0,1=up to 8 discrete LED indicators
      1,0=up to 16 discrete LED indicators
      1,1=up to 24 discrete LED indicators
BIT DEFINITION FOR place holder character “C” (pwm quantity/keypad type)
   bits 4,3=pwm quantity (see motherboard bit 2 for pwm type)
      0,0=no pwm present
      0,1=1 channel (results in one 10 pin header)
      1,0=2 channels (results in one 1 Opin header)
      1,1=4 channels (results in two 1 Opin headers)
   bits 2,1,0=keypad definition:
      0,0,0=no keypad present
      0,0,1=4 keys on one keypad (1×4) non-matrixed
      0,1,0=up to 8 keys on one keypad (2×4)
      0,1,1=up to 12 keys on one keypad (3×4)
      1,0,0=up to 16 keys on one keypad (4×4)
      1,0,1=up to 20 keys on one keypad (5×4)
      1,1,0=universal keyboard connector (16 pin header)
         (includes shift & on/off & up to 35 keys on a 7×5 matrix)
      1,1,1=Human Machine Interface connector (40 pin header)
         (includes display signals & shift & on/off & up to 40 keys on a 8×5 matrix)
BIT DEFINITION FOR place holder character “D” (mother board options)
   bits 4,3,2,1,0=mother board configuration
      bit 4=“1” if RTC present
      bit 3=“1” if 2nd EEPROM present
      bit 2=“1” if 60 hz zero crossing ckt present on motherboard
      bit 1=“1” if KBD scan circuitry present on motherboard (‘HC259 & diodes)
      bit 0=“1” if LED I/O port indicators present on CPU board
BIT DEFINITION FOR place holder character “E” (analog inputs)
   bits 4,3,2=analog input type (bits 4&3=analog type, bit 2=resolution)
      0,0,0=no analog input
      0,0,1=12 bit type “K” thermocouple input
      0,1,0=10 bit 0-5V input
      0,1,1=12 bit 0-5V input
      1,0,0=10 bit 1 K ohm RTD input
      1,0,1=12 bit 1 K ohm RTD input
      1,1,0=
      1,1,1=
   bits 1,0=number of analog input channels
      0,0=one
      0,1=two
      1,0=four
      1,1=eight
BIT DEFINITION FOR place holder character “F” (motion control)
   bits 4,3,2=motion controller (amplifier not configured here, it is entirely separate)
      0,0,0=none
      0,0,1=HCTL 1100 (PLCC)
      0,1,0=PMD 1st generation
      0,1,1=PMD Pilot (serial)
      1,0,0=PMD Pilot (parallel)
      1,0,1=PMD Navigator
      1,1,0=
      1,1,1=
   bits 1,0=number of axis of motion control
      0,0=one
      0,1=two
      1,0=three
      1,1=four
BIT DEFINITION FOR place holder character “G” (communication ports)
   bit 4=Com port 3 (A) signal circuitry (big CPU)
      0=none (TTL level)
      1=RS232
   bit 3=Com port 2 (B) signal circuitry (big CPU)
      0=none (TTL level)
      1=RS232
   bits 2,1=Corn port 1 (TXA1,RXA1) signal type
      0,0=none (TTL level)
      0,1=RS232
      1,0=RS485
      1,1=Radio link
   bit 0=Corn port 0 (TXA0,RXA0) signal type
      0=none (TTL level)
      1=RS232

The Schematic Part Number Generation Source File (e.g. SCH-FIG.INC 180), generates the unique 8 character ASCII part number that is used to reference the top level schematic 320 that contains the correct combinations of low level schematics 330 needed to implement the functions chosen in the True/False Functional Description File 140, when the source files are assembled and linked 430. The 8 character unique part number is embedded within the binary executable 440, which is a result of the Assembler/Linker 430. All that remains is for the system designer to extract the part number from the binary executable, so that specific part number's Net List can be generated. In one embodiment, a file viewing utility that shows embedded ASCII characters can be used to examine the binary executable 440. The ASCII part number is preferably embedded in exactly the same place inside the binary executable, making it easy to find, and record. Using the Net List utility, provided by the Hierarchical Schematic Data Base (200), the Net List (480) can be generated.

In cases where application specific hardware is needed (like specific connectors for example), the system designer can generate a finished level schematic 340 that accepts the top level schematic 320 as a hierarchical schematic. That way, additions and modifications can be made to the finished schematic, without making changes to the schematic library 210.

Source File Library

In one embodiment, the source files in the source file library 110 are written as independent modules (files) in Z180 assembly language. Such ASCII text files, sometimes referred to as “source code,” exist in separate files and have their own file names. To convert these source files into an executable file, the “source” files are “assembled” to create “object” files. The “object” files are then “linked” together to form a “hex” file and a “bin” file. The “hex” file can then be transferred to a PROM Programmer using a serial COM port to program an EPROM. The EPROM holds the final binary executable that is used by the microprocessor to read and run the program. The “hex” file can also be transferred to a FLASH programming utility for programming the versions of CPU's that use FLASH memory. The “bin” file is the binary image of the executable file. This file can be viewed directly to see the contents of the executable file. In particular, the OrCAD schematic name (part number) can be viewed inside the “bin” file.

The name of the module normally (although not always) is an indication of the function of the module. In addition, the last three letters of the modules name indicate what type of module it is. The convention used for the last three letters of a modules name is:
TSK=the module is an independent task
INT=the module is an interrupt
DAT=the module is a data file
SUB=the module contains subroutines or is none of the above

The three-character extension is also an indication of the function of the module. A convention is typically used for the three-character extension of a modules name. For example, the extension, “ASM,” indicates that the file is one of the assembly language source modules that make up the firmware platform. The extension, “INC” indicates that the file is a “INCLUDE” file that is INCLUDED inside an assembly language source module. The extension, “SRC” indicates that the file is an assembly language source module that is not part of the firmware platform.

ProductMaker

One embodiment of the invention is “ProductMaker” from Wilmington Research and Development Corporation of Newburyport, Mass., which (i) facilitates the design of custom controls by providing automatic hardware and firmware generation for common industrial control functions and providing easy incorporation of application specific functions; (ii) provides a low cost Bill of Materials (BOM); (iii) delivers a powerful and widely familiar microprocessor; and (iv) keeps complexity low.

ProductMaker is implemented as a reusable, easily modifiable platform, designed to simplify common control tasks, such as: user interface/menus; machine input/output (I/O); analog-to-digital (A/D) and digital-to-analog (D/A); motion control; temperature control; instrumentation, and others. High level software choices (e.g. true/false settings & macros) allow automated configuration of the entire system (e.g. hardware and executable firmware) leaving only the application specific software to be written in, for example, Z180 assembly (Z80 superset) or in ANSII C using third party C compilers, or some other HLL. A Task Scheduler may be included that multitasks the automatically configured firmware as well as the users compiled (or assembled) firmware. Interrupt Service Routines (ISRs) are also simplified with provided entry and exit code and with real-time debug features to view ISR execution. The automatically configured firmware forms a functioning control with peripheral drivers, tasks, and ISRs. Even with no additional programming beyond the automatic configuration step (e.g. answering true/false questions and compiling/linking/assembling), the system will run, and the control can be exercised.

A single configuration file may be used to automatically assemble the hardware schematics, net-list(s) for the hardware, and executable firmware for the desired functions of the control. While it is possible to use multiple configuration files to achieve the same result, the use of a single file is preferred.

The configuration file(s) can be simple to read (e.g. natural speech “worded” descriptions) and are simple to modify (e.g. text based or graphical representations). Other representations of the configuration file are possible, such as automatic “text to speech” to hear a spoken description of the configuration, or “speech recognition” to allow a spoken description of the configuration. While other representations are possible, the text based and/or graphical based representations are preferred.

The hardware and firmware modules that make up the platform may be designed to anticipate and facilitate modifications and additions to the base level platform functionality, so that the system designer can implement his “application specific” requirements.

“Application specific” firmware can be written in C, C++, JAVA, BASIC, or some other High Level Language specifically tailored to integrate with the functional modules of the hardware/firmware platform.

The results of the automatic hardware and firmware generation can be easily modified using commercial CAD tools for the purpose of aiding the system designer with the “application specific” requirement.

The following modules in Table 1 are common to all ProductMaker platform designed controllers. Not all these files completely assemble during the assemble-link process and as a result, some of these functions may not be present in any specific control.

TABLE 1

| FILE NAME | DESCRIPTION |
|---|---|
| PWRUPSUB.ASM | This is where the software starts from a cold start |
| (150) | (power up). It is responsible for initializing the I/0 |
| | ports, RAM, and interrupt vectors. |
| CATCHINT.ASM | This module contains interrupt handlers for inter- |
| | rupts that are not used, and thus provides gracefully |
| | handling of spurious interrupts. |
| CVASCSUB.ASM | This is a binary to ASCII conversion subroutine (for |
| | integers as well as floating point numbers). |
| EXECTSK.ASM | This is the operator interface and highest level |
| (130) | machine control task. It interprets the meaning of |
| | key pushes, and controls the LCD display. This task |
| | keeps track of the current mode of operation and |
| | determines what to do next. |
| | This task is where most of the “application specific” |
| | code will be found. |
| FLOATSUB.ASM | These are the floating-point math subroutines. |
| INITSUB.ASM | This is the most visible place where firmware |
| | security is implemented. It is responsible for reading |
| | the DS2401 silicon serial number, and enabling or |
| | disabling proper firmware operation. |
| LCDSUBS.ASM | These are utility subroutines used in conjunction |
| (160) | with OPTX2SUB to provide additional functionality |
| | with the LCD display. |
| LEDSUBS.ASM | These are the subroutines used when a seven |
| | segment LED display is present. |
| MAININT.ASM | This is the systems main interrupt routine. It is |
| | selectable within 4 settings from 0.4883 msec to |
| | 1.5625 msec. It is responsible for keyboard |
| | scanning, audible beeps, debouncing inputs, |
| | decrementing timer counters, gating RS232 and |
| | RS485 characters into and out of the micro- |
| | processor, and provides the “Real Time” function- |
| | ality missing from the round robin multi-tasking |
| | operating system. |
| MAINTSK.ASM | This contains routines for reading and writing to the |
| | EEPROM. It also contains the code to keep track of |
| | the number of power ups, total time activated, and |
| | other non-volatile application specific mailbox |
| | totalizing EEPROM locations. (This diagnostic |
| | information can be retrieved by the RS232 interface) |
| MATHSUBS.ASM | These are utility subroutines to load numbers that |
| | are to be operated on (added, multiplied etc.) into a |
| | math scratchpad area. |
| MONTSK.ASM | This is the ROM Monitor Task, which provides the |
| | intelligence behind the RS232 interface. This task |
| | implements a series of simple commands that allow |
| | a RS232 user to view or alter RAM or EEPROM. |
| | There is also a status command, which displays the |
| | EEPROM diagnostic totalizers. |
| MSGDAT.ASM | These are the fixed ASCII messages that are sent to |
| | the LCD display. These are also usually “application |
| | specific”. |
| MULTSUB.ASM | This module contains the system calls, which make |
| (170) | up the multi-tasking operating system. These calls |
| | allow a task to suspend its operation to allow other |
| | tasks to operate. These other tasks in turn suspend |
| | their operation (after running) to let the first tasks |
| | resume. The implementation is round robin and does |
| | not include time slicing. |
| OPTX2SUB.ASM | This module holds the subroutines that interface to |
| | the LCD display. It supports all sizes of text |
| | based LCD modules. |
| RS485SUB.ASM | This contains the subroutines for the RS485 |
| | communication interface. |
| SCANTBL.ASM | This table is used by MAININT to turn the raw |
| | keyboard scan address of a key that is pushed, into |
| | another value that will be used by the rest of the |
| | software. (for example turning a “7” key |
| | into ASCII 7) |
| SERVOTSK.ASM | Independent task to implement the PMD servo |
| | motor controller DSPs. |
| TIMESUBS.ASM | These are the subroutines used when implementing |
| | the Real Time Clock circuit. |
| XYZ.ASM | This is a data file, which is used to initialize the |
| | EEPROM. |
| SYS-FIG.INC | This “include” file is where the system designer |
| (140) | configures the platform. |
| AUTO-FIG.INC | This “include” file automatically sets up additional |
| | system configuration settings based on |
| | SYS_FIG.INC. |
| SCH-FIG.INC | This “include” file automatically generates the top |
| (180) | level OrCAD schematic name which includes all the |
| | desired functions based on SYS_FIG.INC. |

According to one embodiment, the following modules in Table 2 are used on an “as needed” basis in designed controllers. Most of the time, these modules are not required. Occasionally one of these (or another completely new module) prove to be highly useful and easily integrated, and are incorporated into the list of always present firmware modules.

TABLE 2

| | |
|---|---|
| CVBINSUB.SRC | These are the small, integer, to BCD to ASCII, and |
| CVBCDSUB.SRC | back, conversion subroutines |
| CV2ASCII.SRC | |
| CVHXASCI.SRC | |
| INTGRSUB.SRC | These are the integer math subroutines (add, sub, |
| | mult, div) for integers up to 4 bytes long. |
| MAINPRNT.SRC | These are utility subroutines used when a printer is |
| | attached to the control. If a separate task is desired |
| | for printer control, PRINTTSK is also available with |
| | similar functionality. |
| STATSUB.SRC | These subroutines provide math functions, for |
| | calculating mean, standard deviation, and other |
| | statistical functions. |
| CRC16SUB.SRC | Subroutine for calculating a 16 bit CRC. |
| MSTRPAKT.SRC | Subroutine for Master to run “packets” on the |
| | RS485 interface. |
| SLAVPAKT.SRC | Subroutine for Slaves to run “packets” on the |
| | RS485 interface. |
| MOVAVG16.SRC | Subroutine to implement a moving average function |
| | of 16 words. |
| KPADSYS.SRC | Subroutine for implementing numeric keypad entry |
| | for all data types. |

According to one embodiment, “off the shelf” completed circuit boards representing many of the automatically configured schematics are available to the system designer to allow immediate testing of the automatically generated firmware. The circuit boards are designed to plug together (in an analogous manner that the schematic blocks connect together) to give the system designer an instant prototype of the automatically generated hardware. This instant prototype facilitates the product development process from the earliest evaluation phases through alpha product testing. This is a capability that provides hardware for product development with low, or no hardware development cost.

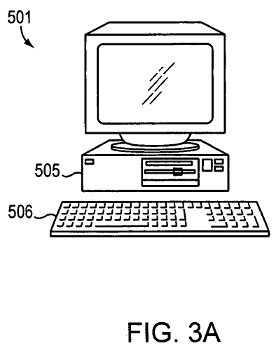

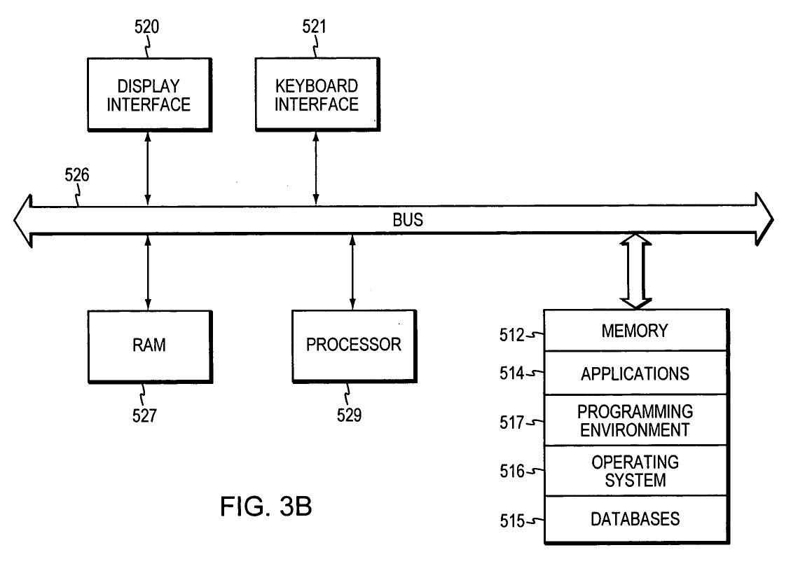

FIG. 3A is a diagram that illustrates a computer system suitable for implementation of the invention according to one embodiment. As shown, computer 501 includes a variety of peripherals, among them being: i) a display screen 505 for displaying images/video or other information to a user, ii) a keyboard 506 for inputting text and user commands. Computer 501 may be a personal computer (PC), workstation, embedded system component, handheld computer, telecommunications device or any device containing a memory and processor.

FIG. 3B is a diagram of the internal structure of a computer system suitable for implementation of the invention according to one embodiment. As illustrated, computer 501 includes mass storage 512, which comprises a computer-readable medium such as a computer hard disk and/or RAID (“redundant array of inexpensive disks”). Mass storage 512 is adapted to store applications 514, databases 515, and operating systems 516. Among the applications stored in memory 512 is a programming environment 517 for automatic hardware and firmware generation and source files.

Programming environment 517 assembles the firmware modules and the included functional description of the desired control to automatically select one of the hardware schematics stored in database 515 and to generate the firmware that executes on that hardware.

Computer 501 also includes display interface 520, keyboard interface 521, computer bus 526, RAM 527, and processor 529. Such applications, including the programming environment and/or embodiments of the present invention 517, may be stored in memory 512 (as above). Processor 529 accesses applications (or other data) stored in memory 512 via bus 526.

Application execution and other tasks of computer 501 may be initiated using keyboard 506 commands from which are transmitted to processor 529 via keyboard interface 521. Output results from applications running on computer 501 may be processed by display interface 520 and then displayed to a user on display 505. To this end, display interface 520 preferably comprises a display processor for forming images based on image data provided by processor 529 over computer bus 526, and for outputting those images to display 505.

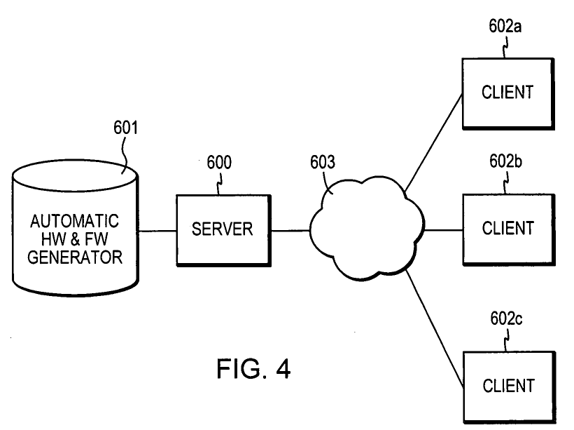

FIG. 4 is a diagram that illustrates a network environment suitable for implementation of the invention according to one embodiment. The configuration process may be done over the Internet 603 with a web page from a server 600 that presents the choices to the system designer. The schematic(s), net-list, and executable firmware can be generated by the automatic hardware and firmware generator 601 then be delivered back to the designer at one or more client 602 over the Internet for test and evaluation. The iterative final design process can also be handled in this manner. This method of accepting configurations and delivering “working” controls executables and documentation over the Internet provides a robust business model opportunity for measuring the number of new designs being generated by a customer and evaluating the value of the tools accordingly. It also hides the internal details of the automatic configuration process to prevent it from being copied. The final configuration can then be emulated on the system designers desktop personal computer, and/or over the internet via a web page. This would allow an effective way to demonstrate the capability of the design suite without any purchases being made.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of automatic hardware and firmware generation, comprising:
providing a plurality of hardware schematics, each schematic having a unique identifier corresponding to a set of functions;
providing a plurality of firmware modules, each firmware module including code for performing a function;
generating a functional description that identifies a desired set of functions;
processing the configuration file and the plurality of firmware modules to generate executable firmware code that implements the desired set of functions and to select one of the hardware schematics that supports the desired set of functions.

2. The method of claim 1 wherein generating the configuration file comprises:
providing a functional description that identifies an available set of functions;
modifying the functional description to enable one or more of the functions from the available set.

3. The method of claim 1 wherein generating the functional description comprises:
providing a graphical representation identifying an available set of functions;
selecting one or more functions from the available set; and
generating a functional description from the selected functions to identify a desired set of functions.

4. The method of claim 1 wherein processing the functional description and the plurality of firmware modules comprises compiling, assembling or linking.

5. The method of claim 4 wherein a firmware module from the plurality of firmware modules is assembled and linked according to whether a corresponding function is enabled in the functional description.

6. The method of claim 1 wherein processing the functional description and the plurality of firmware modules comprises:
generating the unique identifier as a series of bit patterns, the bit patterns selected according to the desired set of functions identified in the functional description.

7. The method of claim 6 wherein the unique identifier corresponds to a high level hardware schematic that comprises a plurality of low level hardware schematics, each of the bit patterns corresponding to one of the plurality of low level hardware schematics.

8. The method of claim 1 wherein each of the plurality of hardware schematics corresponds to a design for a custom control system.

9. The method of claim 1 further comprising:
modifying the selected hardware schematic and the executable firmware code to add application specific functionality.

10. The method of claim 1 further comprising:
providing prefabricated circuit boards to test the generated executable code.

11. The method of claim 1 wherein the executable firmware code including a data field containing a schematic identifier of the selected one of the hardware schematics that supports the desired set of functions.

12. The method of claim 1 further comprising:
providing additional hardware schematics and a firmware module that support a new function, the functional description being capable of identifying the new function;
adding the additional hardware schematics and the firmware module to the plurality of hardware schematics and the plurality of firmware modules respectively for subsequent automatic generation of a hardware schematic and firmware that supports the new function.

13. The method of claim 1 wherein the functional description is an electronic file that is referenced in the code of each of the plurality of firmware modules.
